(19) United States
(12) Patent Application Publication
(10) Pub. No.: US 2022/0083988 A1
(43) Pub. Date: Mar. 17, 2022

(54) METHOD AND SYSTEM FOR BLOCKCHAIN SUPPLY MANAGEMENT OF $100 BILL OR OTHER CURRENCY

(71) Applicant: Christopher A Lynberg, Santa Monica, CA (US)

(72) Inventor: Christopher A Lynberg, Santa Monica, CA (US)

(21) Appl. No.: 17/391,332

(22) Filed: Aug. 2, 2021

Related U.S. Application Data
(60) Provisional application No. 62/706,573, filed on Aug. 25, 2020.
(60) Provisional application No. 63/110,694, filed on Nov. 6, 2020.

(51) Int. Cl. G06Q 20/06; G06Q 20/38

(52) U.S. Cl. CPC G06Q 20/0655; G06Q 2220/00; G06Q 20/389

(57) ABSTRACT

A method and system are provided to supply blockchain management of the $100 bill or any other currency, and to provide a virtualized legal tender backed by a national government.

### CROSS REFERENCE TO RELATED APPLICATIONS

This non-provisional utility patent application claims the benefit under 35 U.S.C. section 119(e) of U.S. provisional application No. 62/706,573 filed Aug. 25, 2020 and of U.S. provisional application No. 63/110,694 filed Nov. 5, 2020, both of which are incorporated, in their entirety, by this reference.

### OVERVIEW

A method and system are provided to supply blockchain management of the $100 bill or any other currency. The system creates a digital cryptocurrency representation of newly minted United States one-hundred dollar bills, or other currency, which are not distributed. The digital cryptocurrency, or virtualized legal tender, may be used and traded by anyone electronically through their banking systems. A National Cryptographic Digital Currency (NCDC) platform can augment the national and global trust and value of the $100 United States Federal Reserve Note by employing a collaborative technology that matches the already established organizational, regulatory, governance, and banking supply chain management structure, creating a modernized infrastructure and architecture for digital fiat currency.

This method and system creates consumable information that is otherwise unattainable. Governments create data and information from their requirements to run their countries' infrastructures, operations, businesses, and economies. Much of this data can be used to a government's advantage if it can be safely released to the public, and can be the impetus for the Federal Data Strategy under the President of the United States Presidential Management Agenda. The Federal Reserve, for example, is interested in finding safe, secure, and trustworthy methods to improve the nation's economics, improve communities, and provide easier and faster access to funds without disintermediating existing financial systems.

This system/method will provide a public consumable supply chain management data platform of its fiat currency. With this method and system, a government will have taken the necessary and sufficient step to assert it has created a nation's cryptocurrency. In essence, this is the creation of a national cryptographic digital currency from the U.S. $100 bill, or other currency, that can be readily utilized through an already familiar user interface in the existing banking system. Using blockchain distributed ledger technologies for this system's architectural design creates a collaborative platform that technologically matches the organizational collaboration that currently exists.

### BACKGROUND

Currently around the world there are many different forms of physical currencies, digital currencies, virtual cryptocurrencies, and emerging Central Bank Digital Currencies (CBDC's). Conventional CBDC, however, anticipates, and fosters, the gradual diminishment and elimination of cash, as do all digital currencies, unlike this method and system. This method and system leverages the fact that the world-wide use of the $100 bill, as an example, is being used, not only as a currency, but as a store of value, printed gold, and therefore is required and not to be eliminated.

CBDC concepts present at least the following problems:
1. There is a risk of CBDC digital bank runs in a cashless society.
2. There is a risk that the market will not be able to convert assets into CBDC.
3. Additional bank deposits are required to start the CBDC.
4. Buying and selling of CBDC's will be required.
5. Incentivization will be required.
6. Disintermediation of trusted banks could occur with CBDC's.
7. Not every person has a smartphone.
8. Identity proofing is not well-established.
9. Large transactions require Anti-Money Laundering/Know Your Customer (AML/KYC) compliance.
10. Scalability is required with increasing demand.
11. Management of Personal Security Keys.
12. Anonymity, privacy, and identity are competing problems.
13. How to interface with existing financial systems.
14. The foundations could fail if they do not meet all the requirements.
15. Cross-border co-operation.
16. Regulatory fragmentation.
17. Market integrity.
18. Consumer protection margins from CBDC's may be insufficient for FANG industries: BigTech versus FinTech.

Economic value is established by communities sharing a common value system. Milton Friedman pointed to the rai limestone of the Micronesian Yapese as the equivalent to the gold stored at Fort Knox. How Rai was traded by ledger is symbolic of modern-day distributed ledger technologies of blockchain. The ledger has simply been improved and digitized.

United States currencies have a world-wide community of value, but there is no world-wide community ledger for participants to interact with, as the Yapese did 1,000 years ago, where the ownership of rai was clear to everyone. Blockchain technologies are creating world-wide virtual communities where there is shared value: company virtual currencies, mobile phone currencies, and other virtual currencies.

The processing of United States currencies is well established with the creation of their physical existence and world-wide distribution. This method/system adds additional processing capabilities and value to the existing world-renowned system.

### SUMMARY OF THE INVENTION

With blockchain technologies, the next step can be taken to create a companion world-wide distributed ledger. This collaborative platform will provide private industries, academia, and governments the ability to participate in the utility of United States fiat currencies. Once established at the egress and ingress points, the United States can build upon this data platform.

There are many positive outcomes from establishing a companion-distributed ledger with United States currencies. One of the outcomes of the new system/method is to eliminate the problem and national threat of non-regulated, non-governmental organizations creating national virtual cryptocurrencies with no assets to back the liabilities.

One purpose of this system is to produce a blockchain supply chain management system of the fiat currency product of the $100 Federal Reserve Note (or other currency) that is being used as a store of value globally, and a method and process for the identification and validation of a $100 bill globally. This method/process also provides the nation's banking system the opportunity to create a national cryptographic digital asset and currency of $100 bills, or other currency, that are stored/vaulted, and not physically distributed.

The Federal Reserve is the United States's bank. Its products include United States fiat currencies, meaning, money which a government declares shall be accepted as legal tender at its face value. Fiat currencies are Federal Reserve Notes, printed by the Bureau of Printing and Engraving. These currencies are released through Federal Reserve Banks, and are utilized as a world-wide currency, community of value, and store-of-value. After the fiat currencies have fatigued/passed their usefulness, these fiat currencies are destroyed by the Federal Reserve. These two end-point states represent the egress and ingress states of fiat currencies, and represent the main control points of a system.

In use, fiat currencies can be in many unknown states of existence. This method and system can publish the existence information of fiat currencies from a 100% Federal Reserve-owned blockchain supply chain management system to the public for purposes of currency identification and verification. This method and system thereby also transform non-distributed fiat currency into a fiat-backed cryptographic digital currency, or virtualized legal tender, but maintain, and do not disrupt, existing financial banking systems based on the existing distributed version of the fiat currency. Non-distributed printed fiat, or its digital twin, provides the proof-of-existence of the fiat-backed cryptographic digital assets, analogous to how gold has functioned in backing the United States dollar. The intrinsic properties of blockchain as a single source of truth, transparency, provenance, immutability, fault-tolerance, and security, provide a digital platform that can augment the value, trust, and usability of existing distributed fiat currency, and a modernized non-distributed vaulted/stored version of the fiat currency as a fiat-backed national cryptographic digital currency and asset.

Blockchain technologies can be applied in many ways to solve differing problems and issues that relate to the need for the attributes that blockchain systems can provide. The primary blockchain characteristics of importance for this method/system are: Consensus, Provenance, Immutability, and Finality.

Blockchain consensus provides a method for a transaction to be valid whereby all participants, who are validating nodes of the data processing network, must agree on its validity, in one implementation.

Provenance is the audit trail over the life of an asset, and participants know where the asset came from and how its ownership has changed over time.

The immutability of a blockchain system/method ensures that, through write-once-only data, no participant can tamper with a transaction after it's been recorded on the ledger and is rendered tamper-proof. If a transaction is in error, a new transaction must be used to reverse the error. Both transactions are visible. Such transactions cannot be modified after creation.

A single, shared ledger provides a unique place to go to determine the ownership of an asset or the completion of a transaction. This finality provides a single source of truth.

When fiat currencies are released and distributed, they become the financial liability of the government. The fiat currency becomes anonymously held by individuals and organizations. Blockchain can provide the same anonymity on a world-wide distributed ledger data network.

This has been proven by the system of bitcoin which utilizes an anonymous permission-less blockchain network. Unfortunately, bitcoin operates under a proof-of-work which requires the expenditure of vast quantities of power to create trust.

By contrast, trust is already in place with the United States government. The proof-of-trust, held by the primary stakeholders, can utilize alternate power-efficient proof-of-stake blockchain systems to create a National Cryptographic Digital Currency (NCDC).

The implementation of this blockchain data network can be viewed as a set of the following architectures: data, network, security, supply chain management, financial, infrastructure, enterprise, organizational, leadership, legal, governmental, and customer-focused architectures. From each of these architectures, economic value can be derived by the augmentation of trust.

Since fiat currencies are already produced, there is no dependency on a blockchain system for the fiat currencies' existence, unlike for a virtual cryptocurrency such as bitcoin. The usefulness of applying blockchain to an existing fiat currency has much greater utility. If a CBDC system were to fail, there would not be an equal value in cash available. Likewise, with a virtual cryptocurrency system failing, there would be no corresponding physical assets which to bank on as a failsafe disaster recovery mechanism. Adding blockchain to an existing fiat currency system is a value added to an already valuable system. Just as the ATM network extended access to cash outside of banks, reduced time delays, reduced industry friction, and added value, blockchain can now extend to edge devices, such as ATM's. With new emerging fourth industrial revolution technologies, the blockchain system/method can engage people and organizations, including the disenfranchised, who have no access to local banks or ATM's.

Some of the problems solved through this system/method are as follows:
1. U.S. fiat currencies which are a U.S. liability are held anonymously as a physical asset store of value. This system/method solves the problem of identifying, verifying, and accounting for U.S. fiat currency through distributed ledger supply chain management technology.
2. This system/method solves the problem of not needing smart contracts within distributed ledgers to create fungibility between fiat currencies and virtual cryptocurrencies.
3. This system/method solves the problem of virtual cryptocurrency market volatilities, and does not require an independent, non-governed, non-regulated, distributed, fiat-backed blockchain token for financial transactions.
4. This system/method solves the problem of not needing to adjust any virtual cryptocurrency blockchain parameters regarding the ownership, approval, legality, policy, regulation, governance, identity, blockchain divisions, or other technical parameters, or government approval. This system/method resolves all these parameters, in one implementation, namely, a blockchain architecture that is wholly centralized and owned by the Federal Reserve. Architecturally, it is a federal-wide platform whereby the intrinsic blockchain properties provide the foundation for a highly secure roles-based collaborative supply chain management method and system for United States fiat currency, and for global identification and verification of world-wide usage of U.S. fiat currency as an asset and store of value.
5. This system/method solves the problem of how the United States government can create the national cryptographic digital asset and currency system through the utilization of its existing financial foundation, its existing digital currency system, and the $100 Federal Reserve Note, or other currency.
6. This system/method reconciles the disconnection between the United States physically distributed $100 fiat currency, or other currency, and the electronic digital currency used, provides a national cryptocurrency solution for the banking industry's threat of disintermediation by virtual cryptocurrencies, and augments the value, security, and trust of the national currency by blockchain supply chain management of the nation's distributed fiat currency as an asset under a unified cash system.
7. Virtual currencies created by virtual organizations have a lack of trust. Participation is risky. This system/method creates a cryptographically based fiat-backed digital currency from an organization of authority, namely the United States, not a virtual currency from a virtual organization.
8. Virtual cryptocurrencies have no organizational financial regulation, making them an unstable and highly variable currency. As a result, such cryptocurrencies typically function as a security investment, not a currency. This system/method creates a regulated and governmentally-backed version of a cryptocurrency of the dollar, which more appropriately and technically is a national cryptographic digital asset, or virtualized legal tender, from the public's perspective.
9. As noted by the Federal Reserve, evolution towards cashless central bank digital currency (CBDC) systems increases the risk of a bank run during a national event when a nation has become cashless. This system/method solves the problem by creating a National Cryptographic Digital Asset (NCDA) based on a store of value of printed fiat currency whereby the US $100 bill, or other currency, is made digitally usable, but physically stored as proof-of-existence. This system/method will also minimize the costs and transportation of cash reserves to the banking industry.
10. A current threat to the banking system is that banks will be disrupted and replaced by virtual currency systems and virtual organizations, called distributed autonomous organizations (DAO's). This system/method reduces/eliminates the risk of banks losing their business from being disintermediated by augmenting existing services based upon the financial backbone of the nation by providing a National Cryptographic Digital Currency (NCDC).
11. This system/method provides linkage for consumers between the physical piece of fiat currency and any public record of its existence. Although the anti-counterfeit technology in the U.S. $100 bill is sophisticated, there is no technology in place beyond the anti-counterfeit measures to check for proof-of-existence or for global supply chain management of the fiat. This system/method cryptographically digitizes the physical fiat and publishes it so that its proof-of-existence can be identified and verified by the public against the published proof-of-existence.
12. Many printing and processing mistakes and problems occur with fiat currencies. Errors that occur in creating a national fiat currency, or in the global supply chain management of fiat, can be captured on a distributed ledger with this system/method so that negative feedback systems can reduce or eliminate the problems and the errors.
13. Current systems of printed fiat currencies lack a public consumer digital interface into digital systems which would allow for integration with existing and future digital currencies. This system/method will allow an individual to verify that an exchange of fiat is trustworthy, and will allow for the modernization of bank accounts, and of older ATM type of technologies to speed transactions, provide faster access to funds, and provide an infrastructure for next generation technologies that can be utilized world-wide.
14. This system/method solves the competitive problem the U.S. is facing with other countries working towards national state-backed cryptocurrencies. Any organization that can utilize a modern technology before its competitors will win economic margins. Organizations that can provide faster access to funds will reduce friction, grow the economy, and win business.
15. Individuals do not know how their digital currencies are backed by the financial industry. With this system/method, anyone can choose to have their account balances backed by cash in vaults, just as gold did historically, which strengthens the national currency, national security, and the trust of what individuals hold.
16. Eliminating cash, as fiat currency, could cause unanticipated adverse consequences. This method/system makes fiat currency safer, and normalizes any societal differences between the wealthy and the unbanked, cash-based poor, for whom bank accounts, credit cards, and loans may be unavailable.
17. Having cash reserves of fiat currency as store of value, solves the problem of where people move their money to when markets are crashing due to national or global events. The global economy uses the $100 bill, or other currency base, as a store of value asset. This system/method makes the $100 bill/other currency base a more valuable asset and trustworthy store of value.
18. This system/method solves the double-spend problem by not creating a virtual currency from a reward system, but instead creating a cryptographic digital currency based on a real fiat currency that will have full provenance, tracking, and traceability. Copying any fiat currency is called counterfeiting. This system provides cash backing for the numbers in an account. The globally distributed supply of $100's, or other currency, can be verified as being singular and unique. Combining the government's trusted fiat currency with creation of trust using the blockchain system/method is synergistic, meaning more powerful than either system alone.
19. This system/method eliminates the problem of an independent or virtual organization creating a national cryptocurrency, which has no equivalent assets to back the liabilities. Instead, this system/method embodies the existing national fiat currency, which defines the difference between a national cryptographic digital currency (NCDC), virtualized legal tender, and a virtual cryptocurrency such as bitcoin.
20. This system/method solves the problem of not requiring vast amounts of power, such as bitcoin requires. The system uses the proof-of-stake for borderless economies rather than the proof-of-work used by bitcoin to secure the network. The existing United States electronic digital currency uses the Federal Reserve's 100% proof-of-stake.
21. This system/method provides a solution to the United States Treasury's problem in combating illicit financing outlined in their National Strategy for Combating Terrorist and Illicit Financing 2020.

The following outcomes follow from an exemplary implementation:
1. Augments the trust of the government's fiat currency
   a. The shared ledger is the single source of truth.
   b. Each node/participant of the decentralized network has a duplicate copy of the ledger, which also provides intrinsic fault-tolerance.
   c. Public blockchains protect privacy, confidentiality, and anonymity by limiting transaction details.
   d. The blockchain network is secured through standardized encryption of data and communications through digital certificates issued by a Certification Authority.
   e. Consensus of the network participants must be reached for a transaction to be valid.
   f. Practical Byzantine Fault Tolerance (PBFT) automatically settles disputes when a computing node has a different result from the other participating nodes which provide the systems' method of consensus and fault tolerance.
   g. Smart Contract security is superior to traditional contracts and reduces costs and delays.
2. The blockchain participants are segmented by functional roles:
   a. The Regulators (Federal Reserve, legal contracts).
   b. Blockchain network operator.
   c. Traditional computing processing platforms that can interface with the blockchain.
   d. Integrated traditional data sources can be used, hashed, and indexed on the blockchain.
   e. Certificates of Authority (CA) for security encryption keys.
   f. Holders of fiat currency or national cryptographic digital currency (NCDC).
3. Value added:
   a. Augments the value of the United States and its currency though augmented trust.
   b. Provides a data platform for emerging technologies to improve security, trust, and usability of fiat currencies.
   c. Reduces financial friction.
   d. Engages the disenfranchised.
   e. Reduces the double spend, counterfeiting, and fraud problems world-wide.
   f. Provides an operational real-time database to perform data science and quantitative analysis.
   g. Enforces implementations of identity management, know your customer, and anti-money laundering regulations.
4. Economic flexibility:
   a. The method/system is a risk averse opportunity towards future innovation.
   b. The method/system can be implemented with a single $100 bill.
   c. The virtualization of legal tender has fewer barriers than legalizing central bank digital currencies or cryptocurrencies.
   d. An unlimited number of connections, collaborations, partnerships, and economies of scale can be explored and established globally.
   e. Participation is an individual choice.

For bitcoin, the proof-of-work and expenditure of power is used to secure the bitcoin blockchain network. For governments, the proof-of-work is performed up-front in the production printing of a secure national regulated government fiat currency. Synergistically combining the methods of printing currency and running a power efficient companion blockchain network provides a cost efficient, stable, secure, trustworthy, and powerful method/system for extending the usability of the national fiat currency as a National Cryptographic Digital Currency (NCDC).

Any digital asset can be incorporated into a blockchain distributed ledger. The architectural implementation is determined by a requirements analysis, and by design and analysis of the engineered system. For one embodiment of the method and system, only the unique hashed identification of the physically printed fiat is required. This unique signature of the piece of fiat will be the identifying information stored on the blockchain distributed ledger, and will minimize the amount of information to be transacted and relayed across the network. As additional fiat technologies are incorporated, additional unique information can be incorporated into the blockchain.

Every piece of information that comprises the origination and genesis of a piece of fiat currency can be placed into the distributed ledger. For every government's implementation, the information contained on the distributed ledger can be customized to meet its information requirements.

With an already established governmental system for creating and producing fiat currency, the first step in creating a national cryptographic digital currency, is to vault, and not distribute, the printed fiat, which has been immutably recorded into the Federal Reserve's distributed ledger NCDC platform when it is created, minted, and manufactured. Different types of currencies and technologies may be used. Once the financial, logistical, and technological decisions are made, and the fiat is created, the information that is used to create the fiat can be placed on the blockchain distributed ledger in the form of a hash. The hash can be created from the digital computer information used to create the product, or from a photographic image, or from its digital twin, or by hashing the serial numbers of the represented denominations.

An optional concurrent case can be implemented where only the digital representation is used on the Federal Reserve's blockchain platform. In this case, no fiat is manufactured. There is no physical fiat to distribute, or store in a vault as proof-of-existence. This alternate would represent a digital twin version of the currency, and the digital twins would be vaulted instead in digital vaults. Many operational, governance, security, legal, and other technical and architectural decision factors may be left to each government and their fiscal laws, regulations, standards, and policies for customized implementations

Information entered onto a blockchain network will remain on the blockchain indefinitely and be available for additional transactions, opening up opportunities for new industries. Lacking any edge devices that can be utilized by outside organizations, or individuals, the physical fiat currency will remain in its anonymous state of existence until it is recalled and destroyed by the Federal Reserve.

In one implementation, a digitally hashed version of a serial number, photographic image, or digital twin, will always remain in its immutable known state of existence in the blockchain distributed ledger database. Once there are end-user devices and applications to interact with the blockchain system, then organizations and people can choose to verify their currency, and make the state of their physical fiat currency known to meet their individual requirements.

Physical fiat currencies that have known existence can provide verification information regarding any financial transaction, such as disputes about counterfeited bills. The government responsible for a specific physical fiat currency is the legally responsible owner, the distributed ledger technology regulator, and the primary owner and stakeholder for the blockchain distributed ledger. The Federal Reserve legally creates and destroys the $100 bill and therefore is the product owner and regulator of the NCDC platform.

FIG. 2 shows the steps to produce, distribute into production, and recall the United States $100 Federal Reserve Note. Putting the fiat currency information on the blockchain system is non-intrusive. The existing Federal Reserve system does not need to be reengineered. Information can be captured at each point along the supply chain management system: decision-making processes, production processes, shipping processes, legal instantiation, distribution processes, recall, and disposition. This blockchain system/method is innovative, not disruptive. In at least one embodiment, this system/method causes no material adverse changes to existing processes. This method/system can be implemented starting with $0 running as an unobtrusive additional data layer and then scale with a controlled, regulated, and governed management.

### BRIEF DESCRIPTION OF THE DRAWINGS

FIG. 1 illustrates a national architecture showing the already established collaborative organizations that are responsible for the nation's United States currency and integration of the matching companion technology platform. In supply chain management practices, the barrier towards the use of blockchain is the problem of establishing the collaborations and contract relationships. Here, intra-governmental collaborations are established to meet the best interest of the nation, thus eliminating the primary barrier towards blockchain adoption.

FIG. 2 shows the network for the creation of the $100 Federal Reserve Note and the creation of a cash asset store of value to be recorded using distributed ledger technology.

FIG. 3 shows a standard computer configuration 300, and the components for operating standard computer applications.

FIG. 4 shows an example blockchain computer configuration 400, and the components for operating as a full participating node on this blockchain.

FIG. 5 shows a set of distributed ledger computing nodes interconnected via secure peer-to-peer network connections with a set of administrative computers and data transactions that are applied against the distributed ledger.

FIG. 6 shows how the basic computer design application information for a $100 Federal Reserve Note design series, without serial numbers applied, represents the digital twin information that can be hashed to provide a unique digital signature.

FIG. 7 shows an example application's hashed output of a photo of a $100 bill illustrated in FIG. 15. Every unique $100 Federal Reserve Note can have a unique digital hashed output.

FIG. 8 shows an exemplary hashed output of the serial number of the $100 bill illustrated in FIG. 15. Every $100 bill may have a unique hashed output. Through this new system, the public can perform anonymous verification against the global public blockchain in FIG. 1.

FIG. 9 illustrates the chaining of blocks of data. The hash signature of the previous block is incorporated into the next block, and forms the linkage between the blocks, providing immutability of the data.

FIG. 10 is a system block diagram showing how customers can interface with a national cryptologic digital currency which is backed by a non-distributed store of value assets of $100 notes. Banks create and operate the cryptographic wallets and keys on behalf of their customers. Banks therefore operate like an exchange, by insulating customers from having to understand the complexities of the national cryptographic digital currency system, and by presenting customers with a bank account view of the system. Bank customers can use their NCDC accounts to transfer funds within their own accounts, or with other customers or organizations.

FIG. 11 shows the network in which physically distributed fiat cash currency is recorded using distributed ledger technology, available information and functionality being provided globally via the Federal Reserve's Public Blockchain Platform, and provides exemplary systems for implementing aspects of the new systems/methods.

FIG. 12 shows how a bank customer can use hardware and software to manage a national cryptologic digital currency account with a bank's management of such an account. The bank will establish the account based on the identity of the customer and incorporate it into the customer's standard accounts management. The bank will be the customer's account custodian, and provide the exchange function and access to the national cryptographic digital currency.

FIG. 13 shows how a user can use hardware and software to perform the identification and verification of the United States of America $100 Federal Reserve Note. The software logic will find and display printing errors on the note, state whether a note may be counterfeit, or appears valid, and whether a note is usable, or should be returned or validated by a bank.

FIG. 14 shows how a user with no hardware or software can deposit a $100 note into the user's bank account without having established an NCDC account.

FIG. 15 shows a permissible illustration of the front and back of a United States $100 Federal Reserve Note.

### DETAILED DESCRIPTION OF THE DRAWINGS

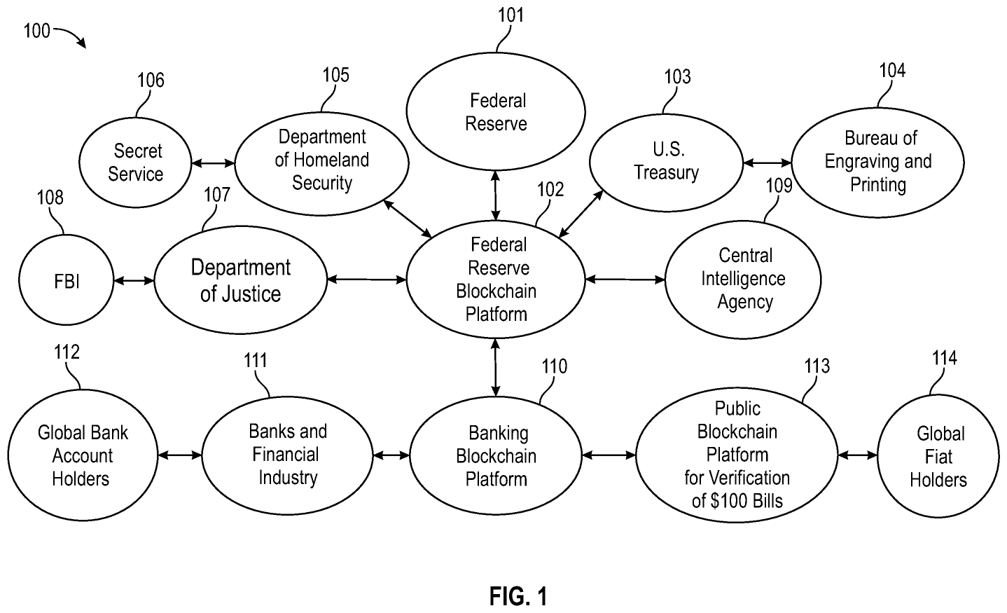

FIG. 1 shows an enterprise architecture for the established collaborative organizations that are responsible for the nation's currency and the matching technology platform. In the transactions between the depicted entities 100, each has independent, interdependent, and collective functions, instructions, messages, orders, delivery, distribution, identification, validation, forensic, and quantitative and qualitative information that is transmitted and received against the distributed ledger technology platform. The proof-of-stake is held by the Federal Reserve. The governance, laws, regulations, and the system/method provide customers with access to digital cryptographic currency, or virtualized legal tender, through an existing banking user interface, and provide augmented trust and value to global customers using the $100 bill, or other currency, as an asset and store of value.

The Federal Reserve 101 was established in the year 1913 as the central banking system of the United States of America. As the regulator of the Federal Reserve Blockchain Platform 102, the Federal Reserve is responsible for the interoperability of the NCDC and connections with the other participating entities that have legal responsibilities, such as: the United States Treasury 103; the Bureau of Engraving and Printing 104 for producing fiat currency; the Department of Homeland Security 105; the Secret Service 106, to combat the counterfeiting of U.S. currency; the Department of Justice 107; the Federal Bureau of Investigation 108, to combat money laundering and other forms of illicit finance; and the Central Intelligence Agency 109 to protect the integrity of the nation's financial system from international counterfeiting and economic terrorism. The Federal Reserve's Blockchain Platform 102 includes the companion Banking Blockchain Platform 110 for inter-banking blockchain transactions among member banks 111 and their account holders 112. The Federal Reserve's companion Blockchain Platform 110 also serves as the intermediary blockchain to process transactions with the Federal Reserve's companion Public Blockchain for Verification of $100 Bills 113 by global fiat holders 114.

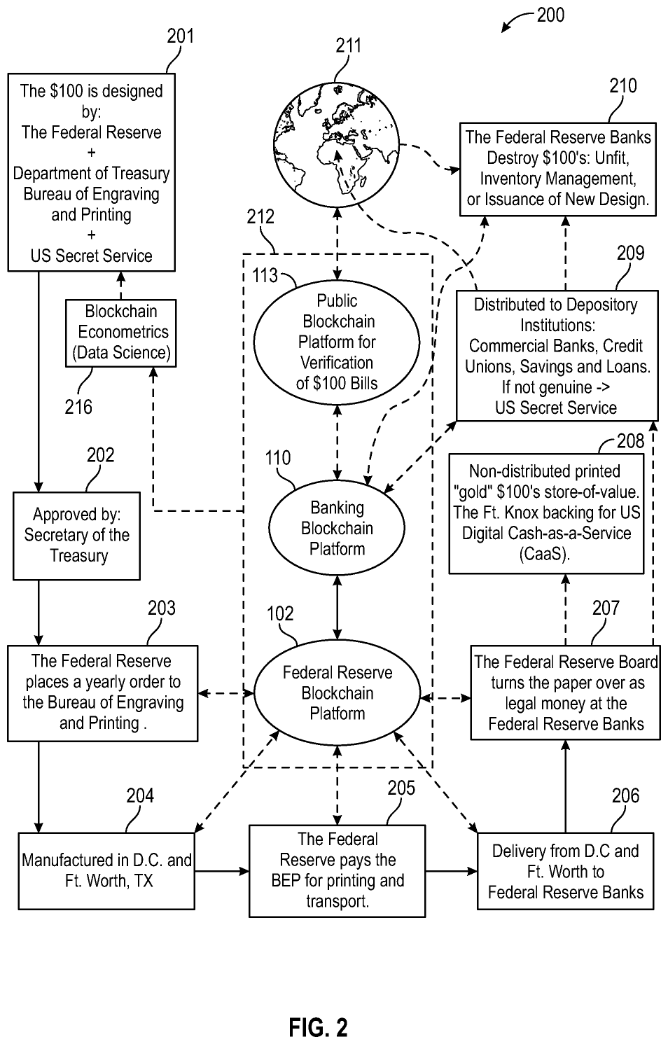

FIG. 2 illustrates an example supply chain management system 200 of the United States $100 Federal Reserve Note. The example blockchain distributed ledger system 212 used in this architecture shows three interoperable blockchain platforms 113, 110, 102 which have different roles in the same applied technology and are capable of atomic swaps (such as the Algorand platform). The core Federal Reserve Blockchain Platform 102 provides internal processing requirements and regulatory decisions by the Federal Reserve. The Federal Reserve's Banking Blockchain Platform 110 facilitates blockchain exchanges between the banking system, and the Federal Reserve Blockchain Platform 102. The Public Blockchain Platform 113 provides the public with additional information about the printed $100 Federal Reserve Notes in the global supply chain management of fiat.

Additional information can be incorporated as needed for the existence and distribution of a government's fiat currency, such as, geospatial and location data, transaction data, existing or pre-existing ownership data, retention data, proof-of-loss data, validation of money theft, and insurance data. Holders of fiat currency may wish to have their cash insured by insurance companies, banks, the Federal Reserve, or other financial institutions or instruments through various applications, by recording their holdings against the public blockchain platform, the banking blockchain platform, or the Federal Reserve's blockchain platform.

The initiation point rests with the decision authorities depicted at block 201, the Federal Reserve (the regulator of the blockchain 1003), the Department of Treasury, the Bureau of Engraving and Printing, and the Secret Service in the design of national fiat currency. Once the currency design is approved by the Secretary of the Treasury 202, a record can be entered onto a distributed ledger 212. The Federal Reserve places an order for the currency to be printed 203, and record can be made on the distributed ledger 212. After the currency is manufactured 204, record is made on the distributed ledger 212 of the manufacture. The Federal Reserve pays the Bureau of Engraving and Printing for the order and transport, at block 205, which is recorded on the distributed ledger 212. Delivery is made from manufacturing to the Federal Reserve Banks 206.

The Federal Reserve makes the decision to turn the paper into legal currency 207. There are two states of existence that the printed cash may take: distributed 209 or non-distributed 208. Cash that is non-distributed, at block 208, becomes an asset store of value that is recorded on the distributed ledger 212, and need not be transported since ownership is recorded on the ledger, as is done for all immovable assets of value.

The Federal Reserve Banks are the egress and ingress points in the system for the distribution and collection of legal tender fiat currency. Currency that is distributed at block 209 into world usage is also recorded on the distributed ledger 212. Currency that has fatigued and outlived its useful functions is collected by the Federal Reserve banks, destroyed at block 210, and recorded on the distributed ledger 212. Any fiat currency that is deemed faulty by the Secret Service 209 is sent to the Federal Reserve Banks to be destroyed at block 210, and removal from circulation is recorded on the distributed ledger 212. The information on the distributed ledger 212 can then be utilized to perform data science, analytics, and econometrics of the system 200 as a feedback control system for ongoing improvement.

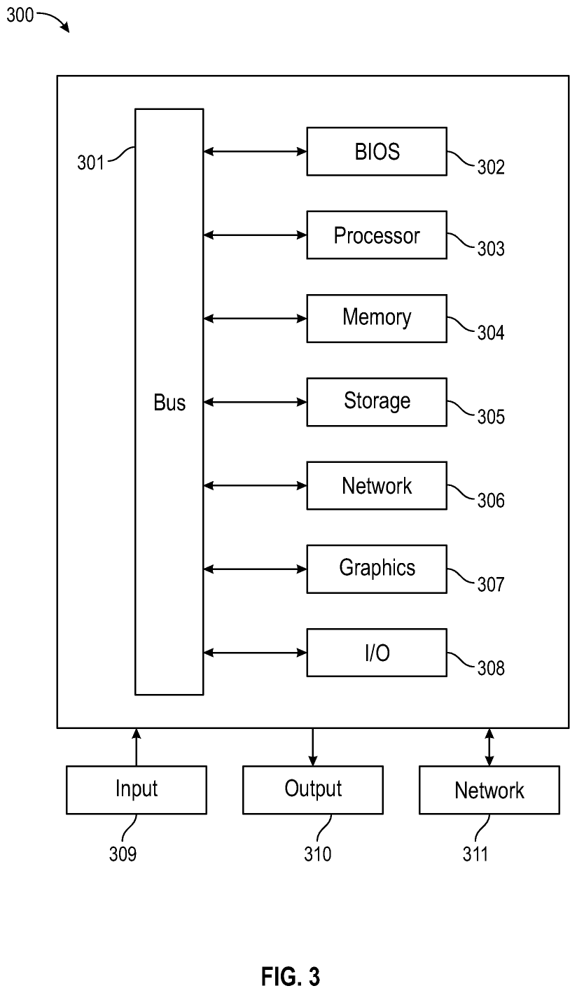

FIG. 3 shows a computer system 300 and the components to operate standard computer applications in one embodiment. System 300 includes an interconnecting bus 301, which enables data processing to occur between the Basic Input Output System (BIOS) 302; the processor 303, which processes the instructions; the volatile memory subsystem 304, which holds the instructions and data to be processed; a non-volatile storage memory 305, which retains processed data; the network subsystem 306 to transmit and receive data against other networking participants; the graphics subsystem 307, for the output display of interactive information; and the Input/Output (I/O) subsystem 308 for additional technologies such as security authentication devices. Computer system 300 interfaces could include input devices 309 such as a keyboard, mouse, microphones, and cameras; and output devices 310 such as speakers, printers, and network connections 311, private and/or public, for administrative and/or data processing. Computer system 300 may represent any computer in the distributed ledger system 212, or elsewhere.

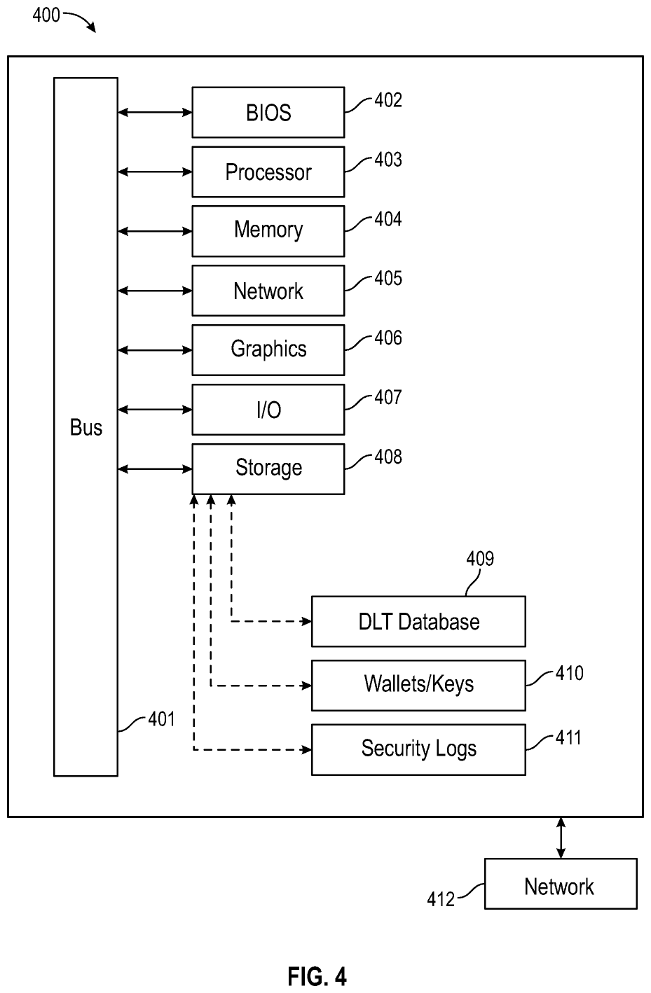

FIG. 4 shows an example blockchain node configuration system 400 and exemplary components to operate blockchain applications. System 400 includes an interconnecting bus 401 which enables data processing to occur between the Basic Input/Output System (BIOS) 402; processor 403 which processes the instructions; volatile memory 404 which holds instructions and data to be processed; non-volatile storage memory 405 which retains processed data; and network subsystem 406 to transmit and receive data against other networking participants. Blockchain nodes can operate in secure and isolated physical data center environments as is done with public or private cloud computing environments with dedicated hardware and the virtualization of servers and services. In one embodiment, only power and a network connection, or a virtual network connection, is required at block 412. The blockchain distributed ledger data is written and read against the DLT (Distributed Ledger Technology) database 409. Wallets and security keys may be stored separately at block 410. Security logs at block 411 may also be stored separately. System 400 may comply with the NSA, DISA, NIST and STIGS (National Security Agency, Defense Information System Agency, National Institute of Standards and Technology, Security Technical Implementation Guides).

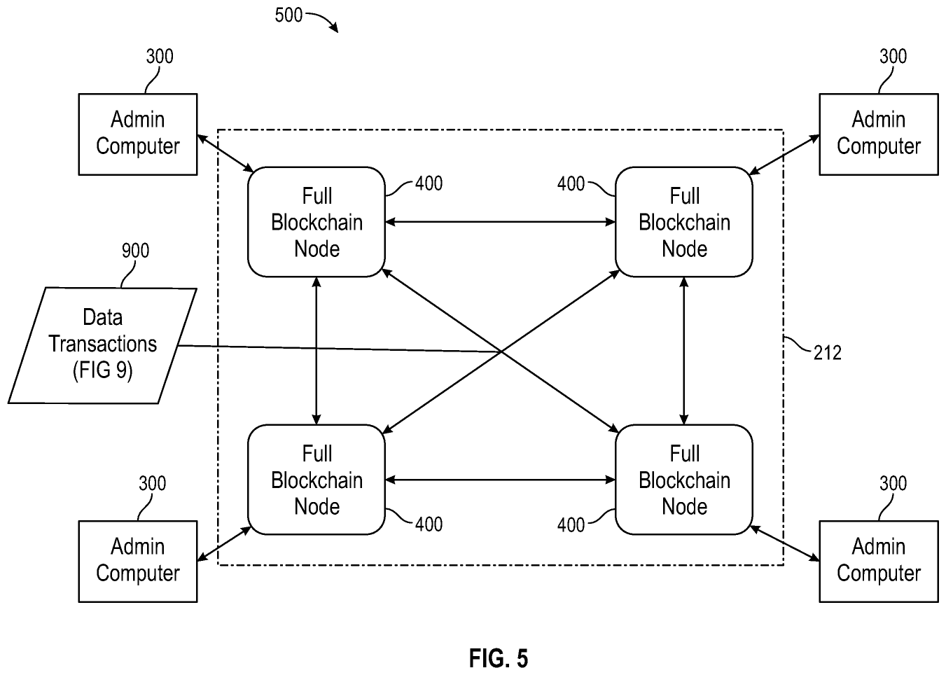

FIG. 5 shows, as an example, embodiment 500 of a set of distributed ledger nodes 300 and 400, forming a core network to provide the foundation for data transactions creating the secure collaborative platform illustrated by FIG. 1 and FIG. 2. An architected system for the Federal Reserve may include a plurality of nodes 300 and 400 with layered security, thereby meeting, in one embodiment, federal physical and cybersecurity recommendations. Core distributed ledger administrative functions may, for example, require multi-signature access by independently functioning administrative computing nodes 400. The distributed ledger nodes may be set up in the example configuration, and cross-connected via secure peer-to-peer networking connections, as illustrated at block 500.

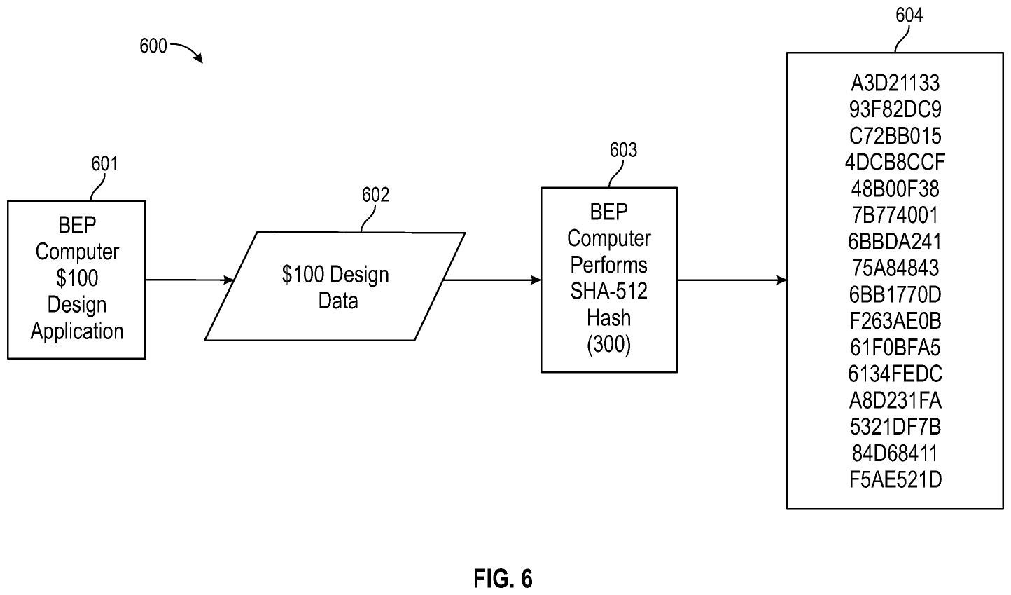

FIG. 6 shows that, in one implementation, the digital hash for every $100 bill in a series, minus the stamped serial number, will have the same digital signature. The information used in a computer application 601 by the Bureau of Printing and Engraving to create the $100 bill represents the $100 bill's digital twin at block 602. Once this design data is hashed at block 603, the digital hash will always be the same, as illustrated by an example hash output 604.

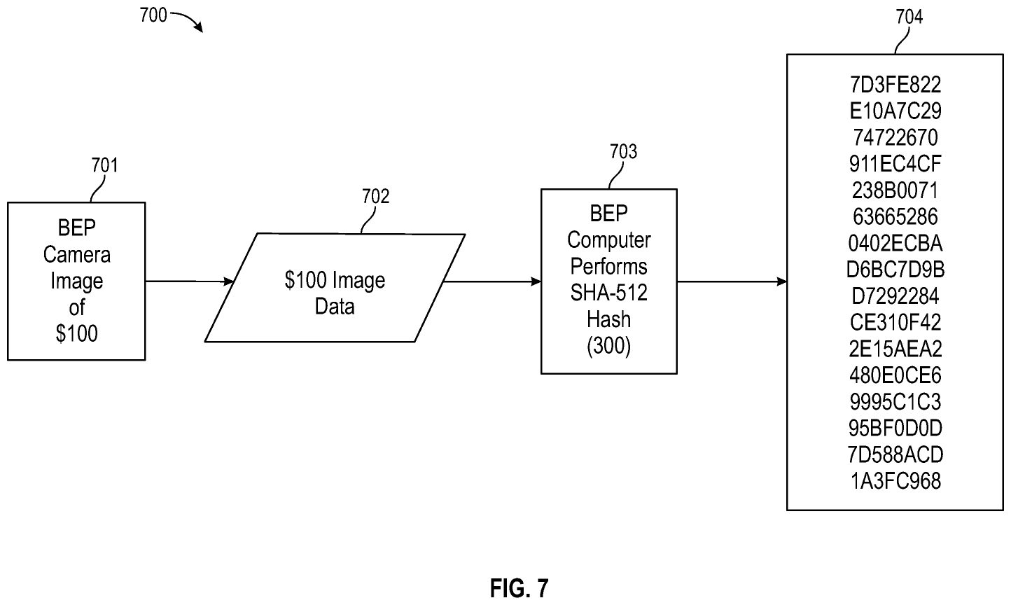

FIG. 7 shows an example of how a Bureau of Engraving and Printing (or other) application can create an image 701 of the $100 bill, receive the resulting data at block 702, perform a standard hash of the data at block 703, and produce a unique digital signature at block 704.

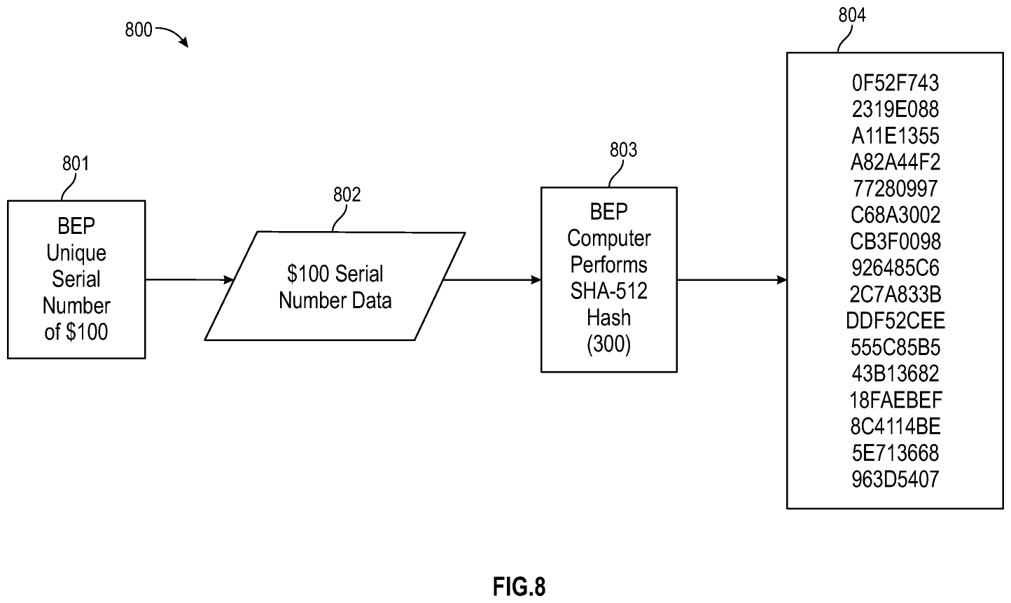

FIG. 8 shows how an application can reproduce the same hashed output 804 that is originally created by the Bureau of Engraving and Printing (BEP) 801 at the time of printing, whereby the serial number data 802 is processed by a standard computer 300 with the standard SHA-512 algorithm 803. Anyone holding a $100 bill can utilize an application of the SHA-512 algorithm to reproduce the same output. That output can be verified as to whether the data was entered on the NCDC as being printed and distributed. If the SHA-512 signature is not recorded on the NCDC ledger, then either the Federal Reserve did not create the $100 bill or the $100 bill predated the system. In this case, only a bank can verify the $100 bill's true form and existence.

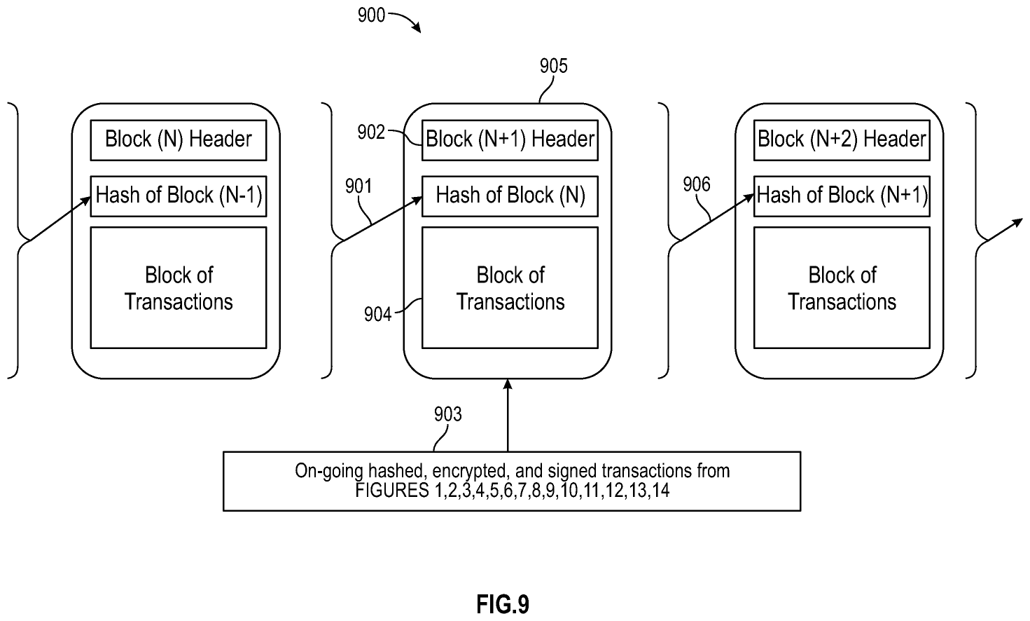

FIG. 9 shows an example of adding electronic transactions from any computer authorized within the blockchain platform 900. The transactions written to the distributed ledger database are authorized for a machine, person, or administrator to perform either through a signatory public-private encryption key, or a multi-signature key at block 900. Many concurrent transactions can take place by participants such as organizations, processes, people, and devices. When a block of transactions is established at block 904 from the transactions from the processes at block 903, the entire block 905, which includes the block hash of the prior block 901, the current block header 902 and the block of current transactions 904, is then hashed 906 and thereby chained to the next block of transactions. In this example, any attempt to change a transaction will result in an error which yields the immutable property of the chaining of blocks of data together. If a change needs to be made, additional transactions are needed to make the change.

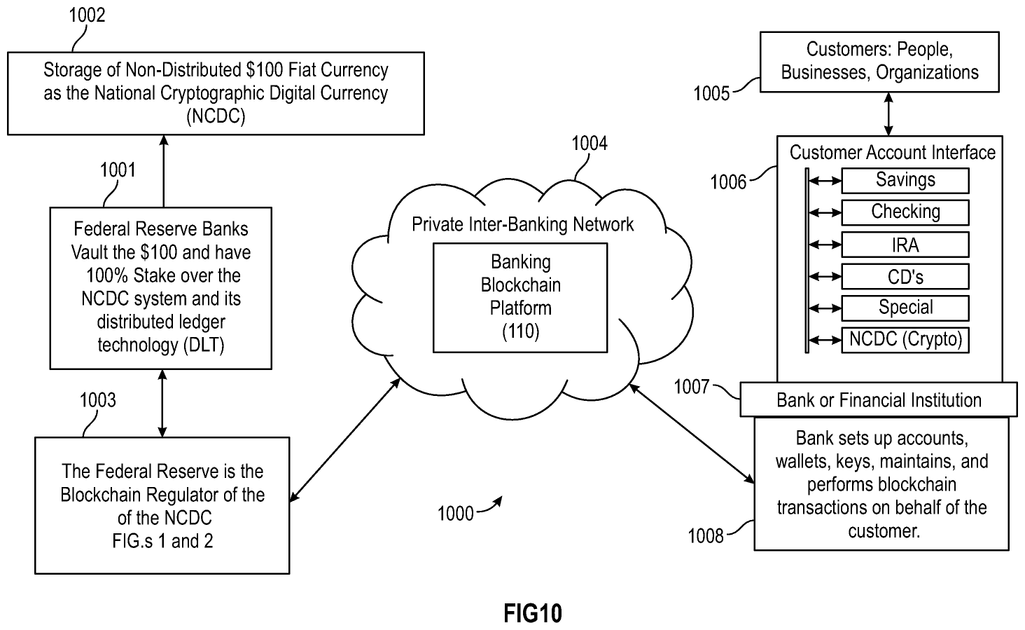

FIG. 10 shows an embodiment of national cryptographic digital currency (NCDC) system perspective and processes where there is no distribution of the government's national $100 printed fiat currency, at block 1000. The Federal Reserve and the Federal Reserve Banks, which have a 100% stake in the $100 Federal Reserve Notes, store the printed fiat currency as the basis, proof-of-existence, and store of value for the NCDC. The Federal Reserve is the legal NCDC blockchain regulator which underlies the NCDC blockchain infrastructure. NCDC customers 1005 interact with the NCDC through their respective accounts 1006. These accounts are created at Federal Reserve participating organizations 1007, which process the cryptographic transactions 1008, on behalf of the customer 1005, and thereby comply with the United States Treasury's Anti Money Laundering (AML), Know Your Customer (KYC), and the Federal government's FedRAMP ID compliance, regulations, and policies.

The cryptographic distributed ledger transactions 1008 that occur between the bank 1007, on behalf of the customer 1005, and the distributed ledger 110, are common transactions utilizing public keys, private keys, and encryption hash functions to place debits and credits on a ledger.

The interface between 1008 and 1004 is commonly used in the cryptocurrency and blockchain exchange system. In this system's case, an example implementation would utilize a blockchain vendor's gateway interface normally used for Point-of-Sale exchanges. This is an example of a Federal Reserve member bank making exchanges with the Federal Reserve blockchain distributed ledger for accounting purposes, and not a Point-of-Sale system making exchanges between products and Federal Reserve digital currency, cash, or cryptocurrency. Bank customers are not aware of the internal exchange operations between member banks and the Federal Reserve system. The banking institution 1007, which, in one embodiment, meets all aspects of financial compliance, functions on behalf of the customer 1005 as an equivalent of current modern-day cryptocurrency exchanges such as Coinbase, and provides a seamless, and non-disruptive system and method for processing cryptographic digital currency.

A customer needs only to understand that the NCDC account and account balance represent fiat backed digital currency. A customer can exchange any denomination of an account balance with anyone else, or with any organization, globally, that also possesses an NCDC account, without apparent intervention. During a national crisis, a customer can be assured that there is real cash backing their accounts, and that the bank will not run out of cash.

This system and method of 1000 can be created by any country using its own fiat currency. The blockchain system at block 110 meets the requirements of the set of organizations participating in the collaborative architecture that is in current operation by a country. There are many different commonly known off-the-shelf commodity blockchain systems that can be utilized such as Hyperledger, and Ethereum. There are also many different consensus algorithms that can be employed. Proof-of-work is commonly used by most virtual cryptocurrencies, but the organizational architecture and collaboration, as shown in FIG. 1, and the 100% liability of Federal Reserve Notes, dovetails with a proof-of-stake technology blockchain architecture. The technical details of these blockchain systems and the cryptographic transactions are available in the open-source repository of GitHub, for example.

Each country may have a different set of architectural requirements for their national platform for cryptographic digital currencies. Adaptations can be made and custom hybrid platforms can be created so that there is a combination of private-permissioned, public-permissioned, and public-anonymous functions, asset creation, atomic swaps, and fungibility of assets for blockchain platforms to meet the requirements of the collaborative organizations.

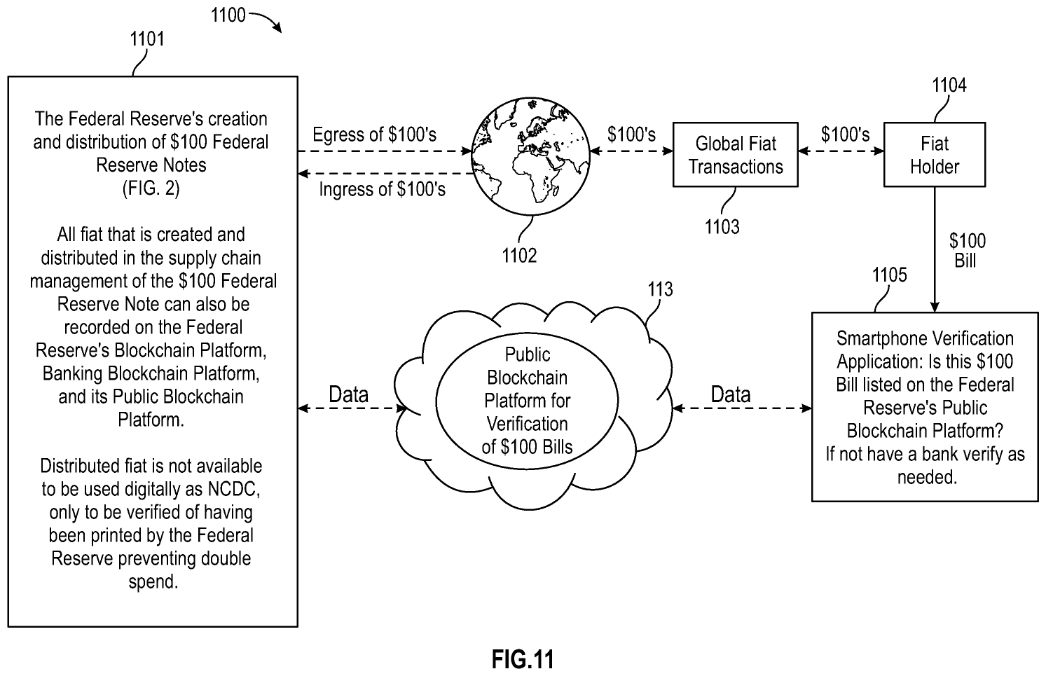

FIG. 11 shows that, as a result of creating a national cryptographic digital currency, and supply chain management system by employing a distributed ledger technology (see FIG. 2) of an existing national fiat currency distributed world-wide, the egress from 1101 to 1102, for world-wide uses 1102, that the holders of fiat 1104 can use computer technologies such as a smartphone and verify that the Federal Reserve system printed the piece of fiat against global public blockchain platform for verification of the $100 bill 1105. The fiat currency reaching the end of its life cycle is returned to its point of origin, to be disposed of by the Federal Reserve System represented by the ingress steps, 1102 to 1101, and resulting transactions recorded.

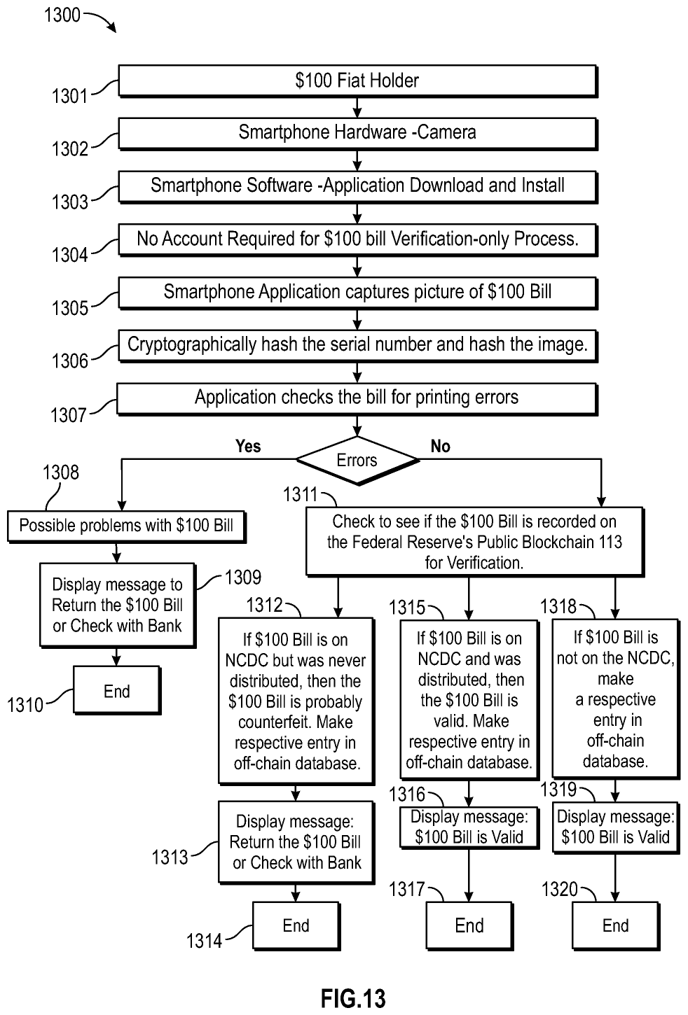

In the physical fiat currency's period of existence, it remains anonymously held, but can be verified against a publicly available distributed ledger technology 1105, or be returned to the Federal Reserve Banks. Additional attributes of fiat can be added into the blockchain distributed ledger database with the consent by the fiat holder, such as geolocation data, transaction data, ownership data, retention data, proof-of-loss data, validation of money theft, and for property insurance due to household disasters. Such information could be utilized by any authorized participating financial processing organizations. The Federal Reserve can use econometric data science to gain valuable information regard the utilization of the $100 bills. FIG. 13 and the related text illustrate the process for a $100 bill holder to perform verification and bank validation as required.

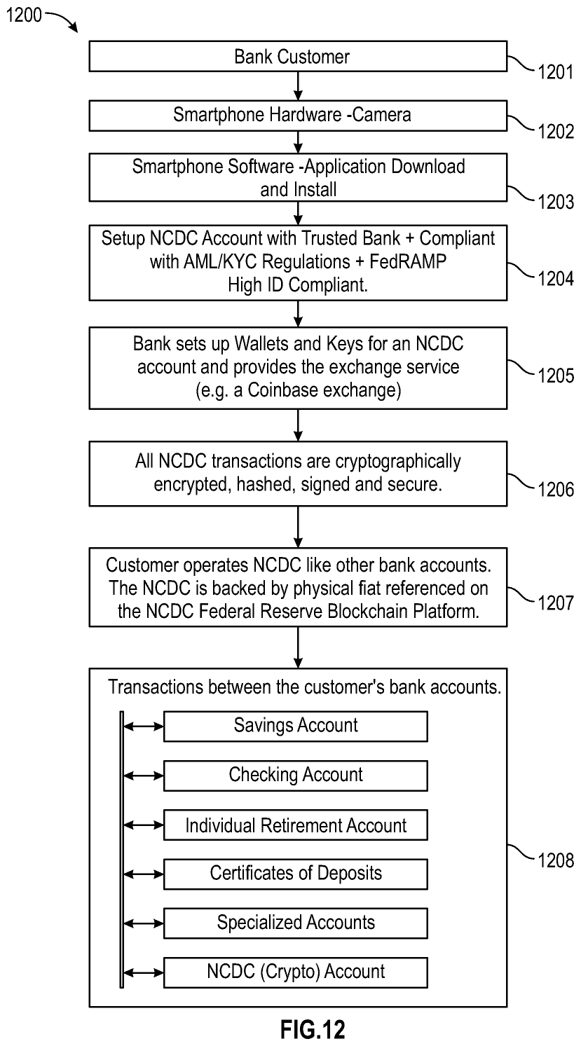

FIG. 12 illustrates the process 1200, showing how a bank customer 1201 establishes a smartphone with a trusted bank to become a user of the National Cryptographic Digital Currency (NCDC) (see FIG. 2). The customer 1201 uses the customer's smartphone 1202, and installs the required software 1203. In one embodiment, the customer 1201 must comply with Federal Anti-Money Laundering (AML) and Know Your Customer (KYC) regulations to participate with a Federal Reserve's owned, governed, and regulated Federal Reserve system. That system must comply with FedRAMP High Identification policy regulations 1204. The customer's 1201 bank will set up the customer's 1201 NCDC account 1204. The bank will store the cryptographic wallet and keys 1205 on behalf of the customer 1201. All transactions with the NCDC will be cryptographically secure 1206 within the NCDC Banking Blockchain Platform 110. The customer 1201 will operate the customer's bank account 1207 routinely, except for the additional NCDC account listed in the customer's bank user interface 1008 (step 1208). Transactions between the customer's 1201 accounts are seamless to the customer in exchanging funds between Checking, Savings, IRA, CD's, Special, and NCDC accounts 1008. The customer 1201 may transfer, exchange, or receive any fractional denomination of the NCDC from/with other participating NCDC account holders world-wide, and thus have peer-to-peer exchanges world-wide without apparent intermediaries.

FIG. 13 illustrates how a $100 fiat holder 1301 can perform anonymous verification of a $100 United States Federal Reserve Note against the Federal Reserve's Public Blockchain Platform. The fiat holder at block 1301 uses the customer's personal smartphone with a camera 1302, and downloads the required software 1303, for which no account 1304 is required to read-only the public blockchain data. User 1301 takes a picture of their $100 bill. The application 1303 performs a cryptographic hash of the serial number and image 1306, and checks the $100 bill for printing errors at block 1307. If printing errors are detected at block 1308, the fiat holder 1301 is informed with a message 1309, and the verification process ends 1310. If there are no printing errors detected at block 1307, the application 1303 compares the hash 1306 information against the Federal Reserve Public Blockchain Platform 113 for verification. If the $100 bill was recorded by the Federal Reserve when it was created, but the $100 was never distributed, then the $100 may be counterfeit 1312. The fiat holder 1301 may either return the $100 bill or have a bank verify the $100 bill 1313, and the verification process ends at block 1314. If the $100 bill was recorded on the Federal Reserve when it was created and the $100 was distributed, then the $100 bill is deemed valid, as block 1315 shows. The fiat holder 1301 is informed the $100 bill is valid at block 1316. The verification process ends at block 1317. If the $100 bill was not recorded by the Federal Reserve when it was created and distributed, the $100 is probably valid and the fiat holder 1301 is notified. The $100 bill is valid 1319 and the verification process ends 1320.

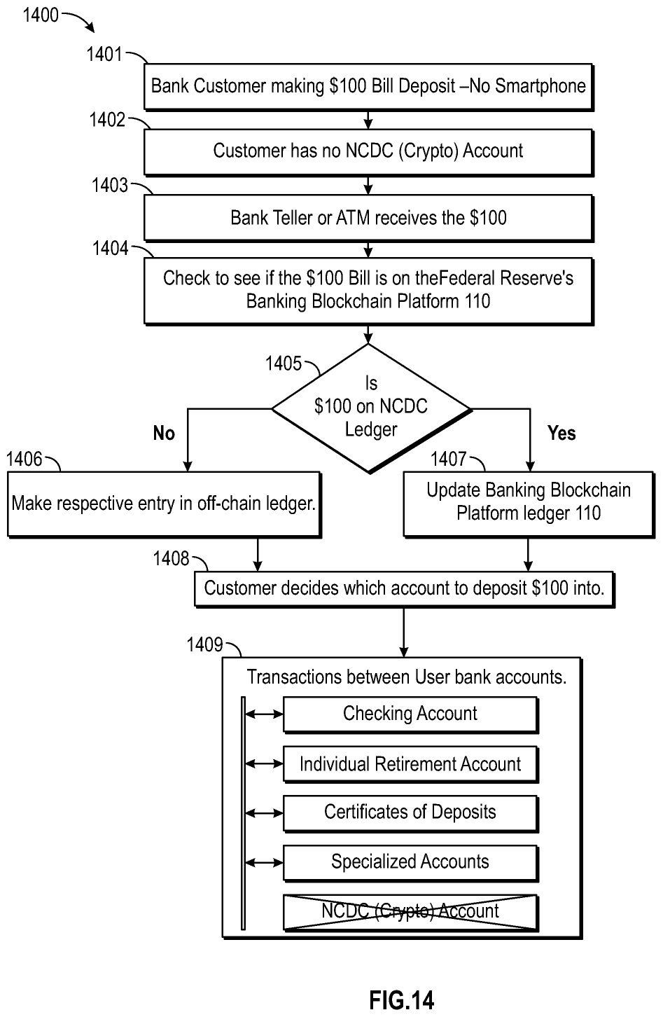

FIG. 14 illustrates process 1400. A $100 bill is processed by a bank when a bank customer has no smartphone or account for processing $100 bills represented on the Federal Reserve Banking Blockchain Platform 110. Bank customer 1401, who has no smartphone, provides the bank with a $100 bill. This customer has no NCDC account and therefore cannot perform verification, as in FIG. 13, or transaction, as shown in FIG. 12.

This bank customer presents the $100 bill to a teller or automatic teller machine (ATM) 1403, where the bill is checked for proof-of-existence 1404. The decision is made whether to record the $100 bill on the ledger 1405. Recording takes place on either the bank's off-chain ledger 1406, or on the Federal Reserve's Banking Blockchain Platform 110. The customer then decides which of the various bank accounts the deposit is to be made, at block 1408. In this instance, the bank customer has not been set up with an NCDC account, wallet, or keys and therefore cannot interact with a NCDC account 1409.

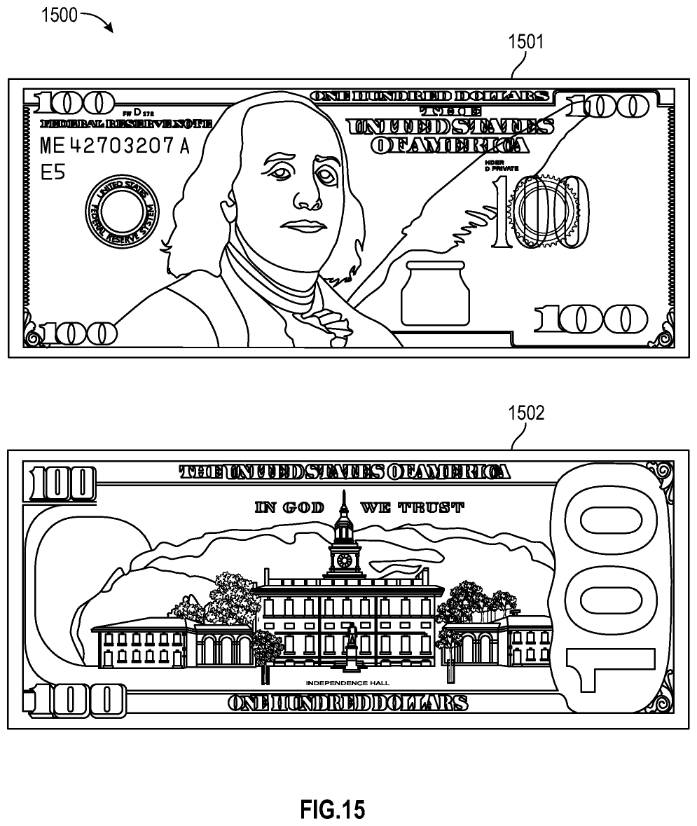

FIG. 15 shows the unique characteristics of the front 1501 and back 1502 of the United States $100 Federal Reserve Note as permitted. The purpose of illustrating the uniqueness of the $100 bill is that it is complex and contains sophisticated anti-counterfeit technologies. Its design seldom changes. Therefore, its digital twin seldom changes. Nor does the hash of the computer information used to create the $100 change often. The element that varies is the serial number. Therefore, the hash of the serial number changes, but can be reproduced by anyone. Its existence can be verified against the Federal Reserve's Public Blockchain Platform 113. Likewise, a digital image of each $100 bill will vary because the serial numbers vary. Therefore, the hash of each $100 image will vary. This method and system can be built for any other denomination of fiat currency, not just $100 bills.

The foregoing description of various embodiments provides illustration and description, but is not exhaustive, and does not limit the methods, systems, and virtualization of legal tender of this invention. Modifications and variations of these embodiments are feasible, and are included within the foregoing specification and the accompanying drawings.

### Glossary

Anti-money laundering (AML): (Code of Federal Regulations § 1020.210) Anti-money laundering program requirements for financial institutions regulated only by a Federal functional regulator, including banks, savings associations, and credit unions. A financial institution regulated by a Federal functional regulator that is not subject to the regulations of a self-regulatory organization shall be deemed to satisfy the requirements of 31 U.S.C. 5318(h)(1) if the financial institution implements and maintains an anti-money laundering program that:
   a. Complies with the requirements of §§ 1010.610 and 1010.620 of this chapter;
   b. Includes, at a minimum:
      1. A system of internal controls to assure ongoing compliance;
      2. Independent testing for compliance to be conducted by bank personnel or by an outside party;
      3. Designation of an individual or individuals responsible for coordinating and monitoring day-to-day compliance;
      4. Training for appropriate personnel; and
      5. Appropriate risk-based procedures for conducting ongoing customer due diligence, to include, but not be limited to:
         i. Understanding the nature and purpose of customer relationships for the purpose of developing a customer risk profile; and
         ii. Conducting ongoing monitoring to identify and report suspicious transactions and, on a risk basis, to maintain and update customer information. For purposes of this paragraph (b)(5 (ii), customer information shall include information regarding the beneficial owners of legal entity customers (as defined in § 1010.230 of this chapter); and
   c. Complies with the regulation of its Federal functional regulator governing such programs.
   d. https://ecfr.federalregister.gov/on/2020-10-14/title-31/subtitle-B-chapter-X/part-1020/subpart-B/section-1020.210
bitcoin: (OED) a type of digital currency in which a record of transactions is maintained and new units of currency are generated by the solution of mathematical problems, and which is independent of a central bank.
blockchain: (See USPTO 10,735,395 Aug. 4, 2020) a distributed database that may be used to maintain a continuously growing list of records, called blocks. In some implementations, each block contains a timestamp and a link to a previous block. A blockchain can be managed by a peer-to-peer network collectively adhering to a protocol for validating new blocks. Once recorded, the data in any given block cannot be altered retroactively without the alteration of all subsequent blocks and the collusion of the network. This allows the blockchain to serve as a data record between parties that is both verifiable and permanent. A blockchain may be spread out over a plurality of nodes (e.g., of a distributed computing system).
cash: (OED) money in coins or notes, as distinct from checks, money orders, or credit.
central bank digital currency (CBDC): (Bank for International Settlements ISBN: 978-92-9259-427-5 (online)) a digital payment instrument, denominated in a national unit of account, that is a liability of a nation's central bank. https://www.bis.org/publ/othp33.pdf
collaboration: (OED) the action of working with someone to produce/create/prevent something.
co-chain: (1^{st} instance use Apr. 23, 2020) concurrent and interoperable public an private blockchains where organizations can isolate and control sensitive data on a private blockchain, while still interacting with the public on a larger scale through an interoperable public blockchain. https://hackernoon.com/co-chains/bridging-public-and-private-chains-as-as-way-to-interoperability-1y3332kg counterfeit: (OED) an imitation of something valuable or important, often made with an intention to deceive or defraud.
cryptocurrency: (OED) a digital currency made by encryption techniques to regulate the generation of units of currency and verify the transfer of funds that operate independently of a central bank.
cryptography: (OED) the art of writing or solving codes.
cryptologic: (OED) of or relating to cryptology; cryptological.
currency: (OED) money in general use in a particular country.
digital fiat: (USPTO 20200090167A1, Mar. 19, 2020) digital currency that is issued and controlled by a nation's central bank.
digital currency: (Central Bank Digital Currency (CBDC): currency that has no physical form and is a record of a currency balance stored in an electronic database.
digital dollar: (https://www.digitaldollarproject.org/publications) a tokenized Central Bank Digital Currency for the U.S., or, a “digital dollar”. This will be a new, additional form of central bank currency issued by the U.S. Federal Reserve.
digital twin: (https://nvlpubs.nist.gov/nistpubs/ir/2021/NIST.IR.8356-draft.prf) The electronic representation/the digital representation of a real-world entity, concept, or notion, either physical or perceived.
distributed ledger: (https://www.worldbank.org/en/topic/finanicalsector/brief/blockchain-dlt) A ledger that uses independent computers (referred to as nodes) to record, share and synchronize transactions in their electronic ledgers (instead of keeping data centralized as in a traditional ledger).
econometrics: (OED) the branch of economics concerned with the use of mathematical methods (especially statistics) in describing economic systems.
edge device: an electronic computing device, sometimes referred to as a client device, which can form an endpoint of a network connection, and is capable of interacting with a server computer system over one or more networks.
egress: (OED) the action of going out of or leaving a place/system federal reserve system:

(https://www.federalreserve.gov/aboutthefed/structure/federal/reserve-system.htm) The Federal Reserve is the central bank system of the United States that includes the Board of Governors in Washington, D.C., and 12 independent regional Reserve banks. This decentralized structure ensures that the economic conditions of all areas of the country are taken into account in the making of monetary policy. The Federal Reserve performs five general functions—conducting the nation's monetary policy, regulating banking institutions, monitoring and protecting the credit rights of consumers, maintaining the stability of the financial system, and providing financial services to the U.S. government.
FedRAMP: (https://www.gsa.gov/technology/government-it-iitiatives/fedramp) The Federal Risk and Authorization Management Program (FedRAMP) is a government-wide program that provides a standardized approach to security assessment, authorization, and continuous monitoring for cloud products and services.
feedback control system: (McGill) A system whose output is controlled using its measurement as a feedback signal. This feedback signal is compared with a reference signal to generate an error signal which is filtered by a controller to produce the system's control input.
fiat: (OED) let it be done.
fiat money: (Oxford Finance and Banking) money that a government has declared to be legal tender, even if it has no intrinsic value and is not backed by reserves. Most of the world's paper money is now fiat money.
fiat currency: (SEC) U.S. Dollars.
hash (Secure Hash Algorithms (SHA)): (NIST) A hash algorithm with the property that it is computationally infeasible 1) to find a message that corresponds to a given message digest, or 2) to find two different messages that produce the same message digest.
ingress: (OED) the action or means of going in or entering.
key: (NICCS) The numerical value used to control cryptographic operations, such as decryption, encryption, signature generation, or signature verification.
key pair: (NICCS) a public key and its corresponding private key.
know your customer (KYC): (The Federal Reserve) a policy that should increase the likelihood that a financial institution is in compliance with all statutes and regulations and adheres to sound and recognized banking practices; such a policy should decrease the likelihood that the financial institution will become a victim of illegal activities perpetrated by its “customers.”; such a policy should protect the good name and reputation of the financial institution; such a policy should not interfere with the relationship of the financial institution with its good customers.
legal tender: (OED) coins or banknotes that must be accepted if offered in payment of a debt.
money: (OED) a current medium of exchange in the form of coins and banknotes; coins and banknotes collectively. See cash, defined above.
monopoly: (OED) the exclusive possession or control of the supply of or trade in a commodity or service.
national: (OED) relating to a nation; common to or characteristic of a whole nation.
nation state: (OED) a sovereign state whose citizens or subjects are relatively homogeneous in factors such as language or common descent.
platform: (MW) plan or design.
private key: (NICCS) A confidential cryptographic key that can enable the operation of an asymmetric (public key) cryptographic algorithm.
public key: (OED) a cryptographic key that can be obtained and used by anyone to encrypt messages intended for a particular recipient, such that the encrypted messages can be deciphered only by using a second key that is known only to the recipient (the private key).
public key cryptography: (NICCS) a branch of cryptography in which a cryptographic system or algorithms uses two uniquely linked keys: a public key and a private key (a key pair).
public key infrastructure (PKI): (NICCS) a framework consisting of standards and services to enable secure, encrypted communication and authentication over potentially insecure networks such as the Internet.
scrip: (OED) provisional certificate of money subscribed to a bank or company, entitling the holder to a formal certificate and dividends.
seigniorage: (OED) profit made by a government by issuing currency, especially the difference between the face value of coins and their production costs.
SHA-512 (SHA3-512): (NIST) a one-way, non-reversible, algorithm used to create a reproducible standard sized encrypted output of unique digital data regardless of the size of the input data. Hash algorithms are called secure because, for a given algorithm, it is computationally infeasible 1) to find a message that corresponds to a given message digest, or 2) to find two different messages that produce the same message digest. Any change to a message will, with a very high probability, result in a different message digest. This will result in a verification failure when the secure hash algorithm is used with a digital signature algorithm or a keyed-hash message authentication algorithm. https://nvlpubs.nist.gov/nistpubs/FIPS/NIST.FIPS.180-4.pdf
stakeholder: (OED) a person with an interest or concern in something, especially a business.
store of value: (https://www.collinsdictionary.com/us/dictionary/english/store-of-value) the function of money that enables goods and services to be paid for a considerable time after they have been acquired.
unified cash system: a system that brings together sovereign fiat cash publicly distributed and non-distributed fiat cash digitally represented and recorded under a coherent architecture of interdependent elements.
virtual: not physically existing as such but made by software to appear to be physically existing.
virtualized: converting (something) to a computer-generated simulation of reality.
virtual currency: a digital representation of value that is used as a medium of exchange, unit of account, or store of value, and is legal tender, and includes in the definition forms of value that can be taken from an originating platform or exchange for legal tender, bank credit, or virtual currency.
virtualized legal tender: regulated and governmentally-backed national cryptographic digital asset, store of value, and cryptocurrency version of the dollar that is used as a medium of exchange, unit of account, and store of value. Virtualized legal tender is legal tender that is backed by its physical manifestation, and is a form of value that can be taken from an originating platform or exchanged for legal tender, bank credit, or virtual currency.

I claim:

1. United States fiat currency having a unique blockchain identifier.

2. Blockchain digital fiat.

3. The fiat of claim 2 wherein the fiat is currency.

4. The fiat of claim 2 wherein the fiat is used by the United States.

5. Virtualized United States legal tender.
